(19) United States
(12) Patent Application Publication
(10) Pub. No.: US 2015/0225996 A1
(43) Pub. Date: Aug. 13, 2015

(54) BLINDS SYSTEM FOR INSTALLATION BETWEEN TWO INSULATED WINDOW PANES

(71) Applicant: Zoran Maksan, Biogradna moru (HR)

(72) Inventor: Zoran Maksan, Biogradna moru (HR)

(73) Assignee: Boran Glavas

(21) Appl. No.: 14/424,410

(22) PCT Filed: Aug. 27, 2012
(86) PCT No.: PCT/HR2012/000018

§ 371 Date: Feb. 26, 2015

(51) Int. Cl. E06B 9/264; E06B 9/32; E06B 9/303

(52) U.S. Cl. CPC E06B 9/264; E06B 9/303; E06B 9/32

(57) ABSTRACT

Present invention refers to the blinds that are found in a closed space between two window panes (2; 3), and which are regulated by magnets from the outside, particularly to the guiding means between two window panes (2;3). Magnets are placed between window panes in the inner battens (4.1;7) while controlling battens (5; 6) are arranged from the outer side of the inner window pane (3) and serve for lifting or lowering of the blinds. At the end of the battens (5, 6, 7 and 4.1) are arranged end parts (4.2) and (5.6) containing magnets (8a, 8b, 18a and 18b). Each inner top/bottom contact magnets (8a; 18a) are fitted to be in the opposite magnet pole in relation to the poles of the external top/bottom contact magnets (8b; 18b) on the external top and bottom regulating batten (5; 6). Magnets hosed in the end parts (5.6) of the external battens (5; 6) attract magnets housed in the end parts (4.2) of the inside battens (7; 4.1). After installing the inner part of the blinds, the space between the window panes is permanently sealed from the environment. One of the characteristics of the invention is frame of the insulated window glass that consists of two pair of aluminum profiles where on the upper and lower end of the insulated window glass are arranged mutually opposed profiles (1.1) and laterally are arranged mutually opposed rails (1.2). Lateral rails (1.2) are designed in a manner that contain axle pin 4.4 that gets into keyway (4.5) positioned on contact surface of the end parts (4.2) whereby rails (1.2) have function of guides and spacers at the same time. By present technical solution, any contact of external/internal batten assembly and blinds (12) with the window glass is prevented thus preserving in good condition of applied Low-E coating on the any side of the window pane.

### TECHNICAL FIELD

Present invention refers to the blinds that are found in a closed space between two insulated window panes, and which are regulated by magnets from the outside, particularly to the guiding means between two window panes. According to the ECLA the invention is classified as E06B9/32.

1. Technical Problem

Problems that appear in the use of classic blinds are: a relatively complicated mechanism for their regulation, a decreased lifetime because of the exposure to all influences, complicated cleaning, impossibility to take the entire blinds down, bad thermal and sound insulation and an unnecessary complex assembly for the end user. Mentioned technical problems are solved with external/internal bottom and top assembly with magnets that operate blinds in a manner to lift and lower with the external/internal top/bottom assembly. In view of energy saving, insulating window glass is implemented as a standard. Insulated window glazing refers to windows with two or more panes of glass. They are also called double-glazed, triple-glazed, and—sometimes more generally—storm windows. To insulate the window, the glass panes are spaced apart and hermetically sealed to form a single-glazed unit with an air space between each pane of glass. The glass layers and the air spaces resist heat flow. As a result, insulated window glazing primarily lowers the U-factor, but it also lowers the solar heat gain coefficient. Some window manufacturers use spacers—which separate two panes of glass—that conduct heat less readily than others. These spacers can further lower a window's U-factor. In order to improve energy savings Low-emissivity (Low-E) coatings on glazing or glass are applied which control heat transfer through windows with insulated glazing. Windows manufactured with Low-E coatings reduce energy loss by as much as 30%-50%. A Low-E coating is a microscopically thin, virtually invisible, metal or metallic oxide layer deposited directly on the surface of one or more of the panes of glass. The Low-E coating reduces the infrared radiation from a warm pane of glass to a cooler pane, thereby lowering the U-factor of the window. Different types of Low-E coatings have been designed to allow for high solar gain, moderate solar gain, or low solar gain. To keep the sun's heat out of the house (for hot climates, east and west-facing windows, and un-shaded south-facing windows), the Low-E coating should be applied to the outside pane of glass. If the windows are designed to provide heat energy in the winter and keep heat inside the house (typical of cold climates), the Low-E coating should be applied to the inside pane of glass. In order to prevent damage caused by sliding of the external/internal top/bottom assembly with magnets and of the blinds itself, technical problem solved by the present invention concerns the specially designed spacers and internal assembly between two window glass that prevent any contact of external/internal top/bottom assembly and blinds with the glass.

2. State of the Art

There were many attempts to solve some of the above-mentioned problems, but none of them succeeded to solve all mentioned flaws in a simple and financially acceptable way. It is not possible to take down whole blinds. Known solutions for the regulation of blinds through magnets do not solve the lifting of a larger surface of blinds. A motor-operated regulation of Venetian blinds between window panes is expensive, unreliable and requires electric energy consumption. According to the document EP2271813 the space between the window panes could be completely sealed from the environment, after the blinds regulated by magnets have been installed. Magnets are placed between window panes in the freely rotating bearing hollow pipe and in the bottom bearing rail together with the related strings, that is ladder which hold the individual slats or strips of the blinds. After installing the inner part of the blind, the space between the window panes is permanently sealed from the environment. Such insulation glass is placed in a window or door. All that is necessary for using and regulating the Venetian blinds are the bottom and top external rail, which enable the Venetian blind to be: rotated around the longitudinal axis for 180°, lifted and lowered by the external bottom batten, and lifted and lowered by the top external batten or moved diagonally. Technically, the solution presented by present invention differs from the document EP2271813 in that blinds can not rotate around their longitudinal axis for 180°; inner and outer battens are not in direct contact with the window glass thus preserving in good condition of applied Low-E coating on the any side pane of glass.

### DISCLOSURE OF THE INVENTION

Present invention represents functional and simple solutions for lifting and lowering of classical venetian and pleated blinds set between two insulating window-pane. System is fully magnetic and cordless which makes it unique and different then any other existing integrated system. The core of the invention is that the space between the two window panes 2; 3 could be completely sealed from the environment, after the blinds regulated by magnets have been installed, and any contact of external/internal batten controlling assembly and blinds with the window glass is prevented. Magnets are placed between window panes within the battens 4.1; 7 while controlling battens 5 and 6 are arranged from the outer side of the inner window pane 3 and serve for lifting or lowering of the blinds.

Blinds system for installation between two insulated window panes (2; 3), the system comprising a window frame (5.8) bounding frame of the insulated window panes (2; 3) that consists of a pair mutually opposed profiles (1.1) and of a pair mutually opposed rails (1.2), blinds external (5;6) and internal (4.1;7) battens, where at the end of the battens (5, 6, 7, 4.1) are arranged end parts (4.2) containing at least one magnet (8a; 18a,) and end parts (5.6) containing at least one magnet (8b and 18b) where magnets (8a; 18a) are fitted to be in the opposite magnet pole in relation to the poles of the magnets (8b; 18b), where rails (1.2) are arranged to house opposite end parts (4.2) of the at least one batten (4.1; 7), wherein both rails (1.2) include a longitudinal flat tracks (1.3) and (1.4) arranged at a right angle for housing an end parts (4.2) of the at least one batten (4.1; 7), such the end parts (4.2) of the batten (4.1; 7) may slide along said rails (1.2) in said longitudinal flat tracks (1.3) and (1.4), the longitudinal rails (1.2) include a longitudinal axle pins (4.4) positioned at a right angle on the longitudinal track (1.4), the pins (4.4) being arranged to get into keyways (4.5) of the end parts (4.2) in order to restrict the contact of internal (4.1;7) batten assembly and blinds (12) with the window panes (2; 3) and to ensure only the longitudinal movement of the battens (4.1; 7) along the rails (1.2).

One of the characteristics of the invention is frame of the insulated window glass that consists of two pair of aluminum profiles where on the upper and lower end of the insulated window glass are arranged mutually opposed profiles 1.1 and laterally are arranged mutually opposed rails 1.2. Lateral rails 1.2 are designed in a manner that contain axle pin that gets into keyway positioned on contact surface of the end parts 4.2 whereby rails 1.2 have function of guides and spacers at the same time. By present technical solution, any contact of external/internal batten assembly and blinds with the window glass is prevented thus preserving in good condition of applied Low-E coating on the any side of the window pane.

### BRIEF DESCRIPTION OF FIGURES

Hereafter follows a detailed description of the invention with reference to figures, where:

FIG. 1 shows from prior art the frontal look to the window with the installed Venetian blind;

FIG. 2 shows from prior art the perspective of the Venetian blind with the freely rotating bearing pipe and the external top batten with magnets;

FIG. 3 shows from prior art the inner top contact magnets 8a and 8b according to the two modes of invention;

FIG. 4 shows view from the outside of the window frame with assembled blinds between two panes of glass;

FIG. 5 shows view from the inside of the window frame with assembled blinds between two panes of glass;

FIG. 6 shows the side frame guide profile 1.2;

FIG. 7 shows perspective view of the element 4.2 for bearing inner magnets 8a and 18a;

FIG. 8 shows perspective view of the assembled side frame guide profile and element 4.2;

FIG. 9 shows perspective view of the external regulating battens 6; 5;

FIG. 10 shows view of the element 5.6 for bearing external magnets 8b and 18b;

FIG. 11 shows perspective view of the assembled element 5.6 and external regulating batten 6;5;

FIG. 12 shows square tube 4.1; 7 with extension for fixation of blinds;

FIG. 13 shows perspective view of the assembled square tube 4.1; 7 with blinds; and

FIG. 14 shows another embodiment end parts 5.6 and longitudinal guide 5.9;

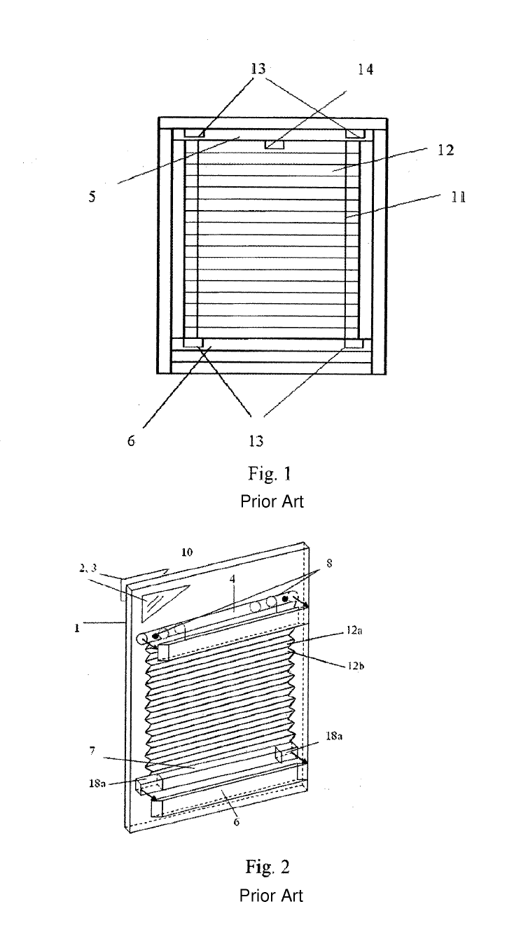

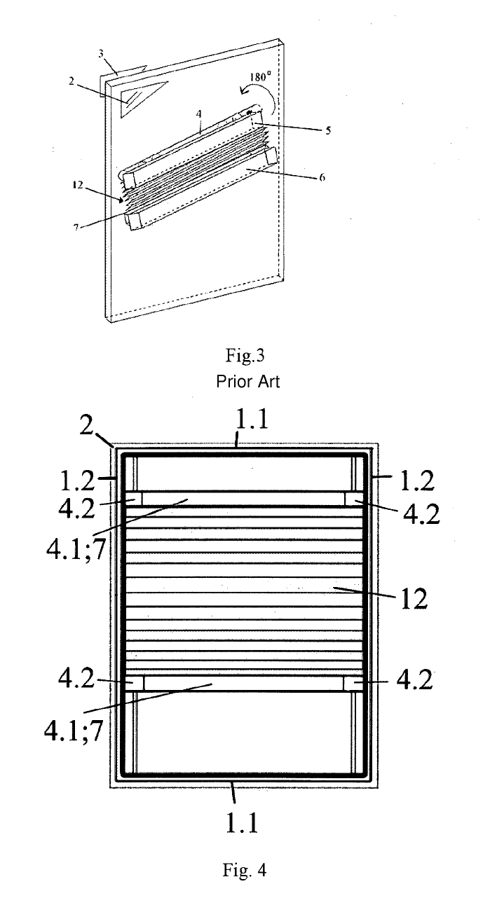

### DETAILED DESCRIPTION OF THE BEST MODE OF INVENTION

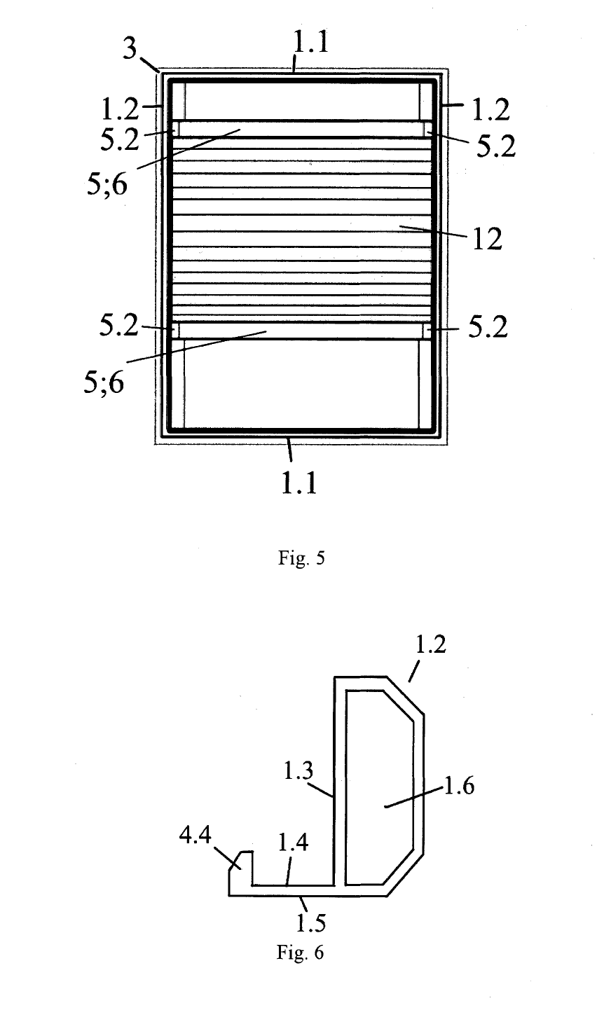

FIGS. 4 and 5 show a schematic view of a blinds system in accordance with one embodiment of the invention, where blinds are installed between two window panes 2; 3. The shown system comprises two blinds controlling battens 5 and 6 arranged from the outer side of the inner window pane 3 which serve for controlling the position of the blinds and two inside battens 7 and 4.1. At the end of the battens 5, 6, 7 and 4.1 are arranged end parts 4.2 and 5.6 containing magnets 8a, 8b, 18a and 18b. Each of the said end parts contains at least one magnet, but the number of housed magnets depends on the size and the weight of the blinds. Each inner top/bottom contact magnets (8a; 18a) are fitted to be in the opposite magnet pole in relation to the poles of the external top/bottom contact magnets (8b; 18b) on the external top and bottom regulating batten (5; 6). Magnets hosed in the end parts 5.6 of the external battens 5, 6 attract magnets housed in the end parts 4.2 of the inside battens 7 and 4.1. In order to move the battens the magnetic force between inner and external magnets needs to be overcome. Hence, the magnet should be strong enough to hold the weight of the batten and the blinds, but not too strong so as to produce an obstacle for the operator wanting to adapt the position of the battens.

Frame of the insulated window glass consists of two pair of aluminum profiles where on the upper and lower end of the insulated window glass are arranged mutually opposed profiles 1.1 and laterally are arranged mutually opposed rails 1.2.

The rails 1.2 are shown in detail in FIG. 6. Rail 1.2, in FIG. 6, has cross section in the form of the bisected octagonal hollow tube 1.6 with additionally containing elongated part 1.5 extending from one end of the tube 1.6. Generally, the rails 1.2 are formed by bisected longitudinal hollow tube 1.6 sealed with the longitudinal flat track (1.3) and elongated part 1.5 extending from one end of the hollow tube where on the end of elongated part 1.5 an axle pin 4.4 is arranged, perpendicular to the elongated part 1.5 in a manner that pin 4.4 is parallel with longitudinal track 1.3. Both rails 1.2 include a longitudinal tracks 1.3 and 1.4, and the axle pin 4.4 for housing an end parts 4.2 of the inside battens 7, 4.1.

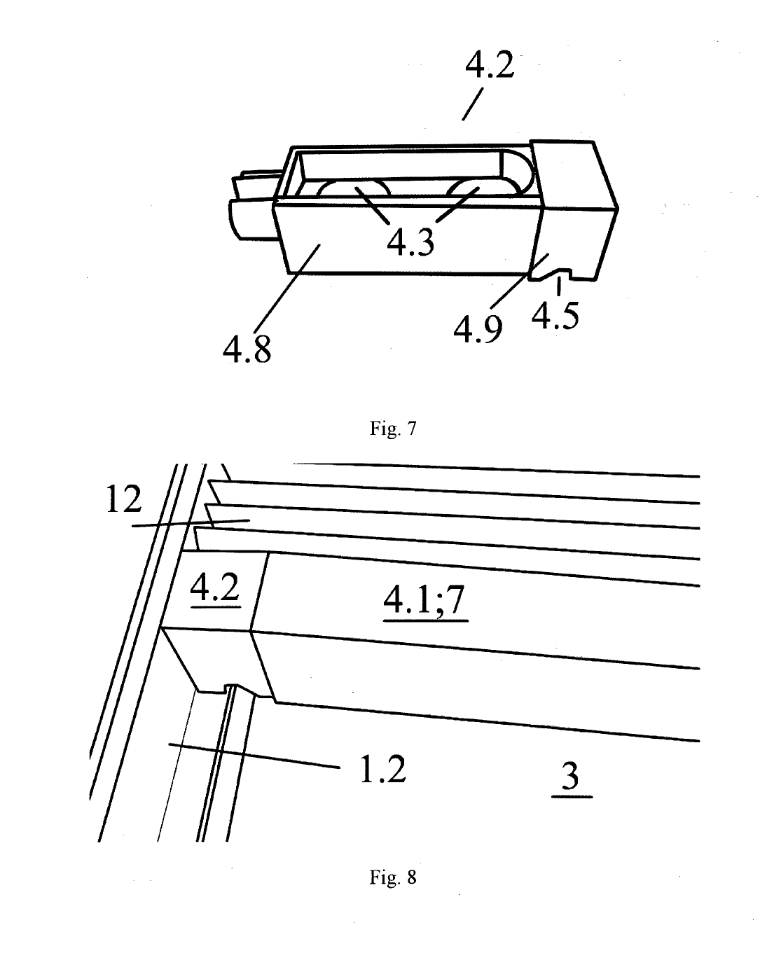

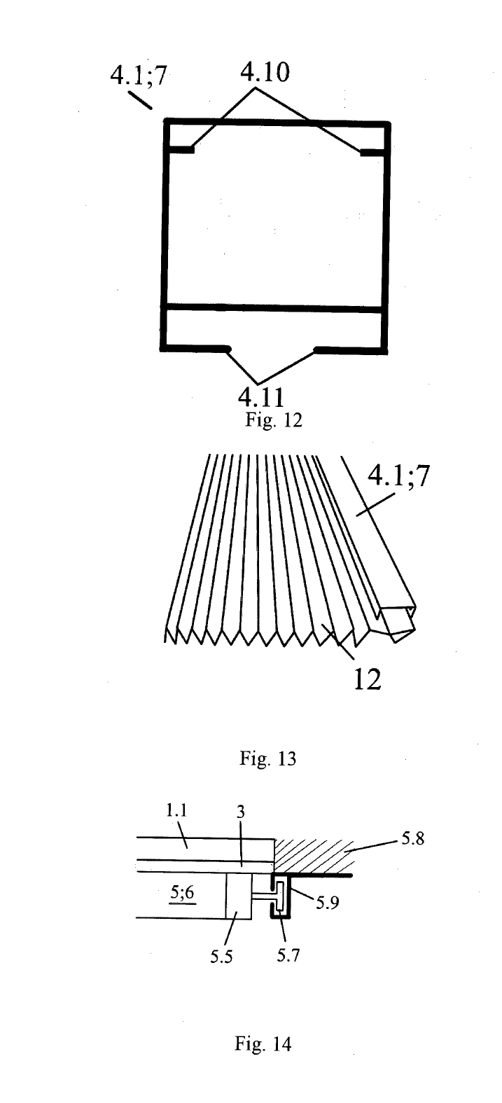

The end parts 4.2 of the inside battens 7 and 4.1 are shown in detail in FIG. 7. The end parts 4.2 of the inside battens 7 and 4.1 are provided with at least one magnet 8a; 18a arranged to bond to the magnets 8b; 18b in order to restrict the longitudinal movement of the battens 7 and 4.1 along the rails 1.2. End part 4.2 is made in one piece that consists of a rectangular part 4.8 for housing magnets and fitting part 4.2 inside battens 7 and 4.1, and of a part 4.9 that glides along the rails 1.2. The part 4.8 for housing magnets, on the side that is facing inner window pane when the blinds system is assembled, has cavity 4.3 which contains at least one socket 8 for placing at least one magnet 8a. The part 4.8 for housing magnets has cross section and size that enables its fitting within battens 7 and 4.1. Furthermore, the part 4.8 on the edges, that are facing the inner window pane 3 when blinds system is assembled, contains two longitudinal slots that serve for fixing part 4.8 inside battens 7 and 4.1. The battens 7 and 4.1, see FIGS. 12 and 13, are in the form of the square tube with the extension 4.11 for fixation of the blinds. The inner part of the square tube of the battens 7 and 4.1 is provided with two oppositely placed projections 4.10 that serve for receiving two longitudinal slots and tightly securing parts 4.8 inside battens 7 and 4.1. The part 4.9 of the end part 4.2 has cross section and size that enables its adhering to the battens 7 and 4.1. The part 4.9 is formed by five mutually perpendicular flat surfaces where the surface oriented to the window pane 3 is contact surface provided with the longitudinal keyway 4.5 extending along the said surface. Keyway 4.5 has the shape and size that matches to the longitudinal axle pin 4.4 and its position is determined by the width of the longitudinal track 1.4 in a manner that when blinds system is assembled, see FIG. 8, the end parts 4.2 of the battens 4.1; 7 may slide along said rails 1.2 in said longitudinal tracks 1.3 and 1.4. The longitudinal axle pin 4.4 of both rails 1.2 and contact surface provided with the longitudinal keyway 4.5 ensure only the longitudinal movement of the battens 4.1; 7 along the rails 1.2 and thus only lifting and lowering of the blinds 12 arranged between the two window panes.

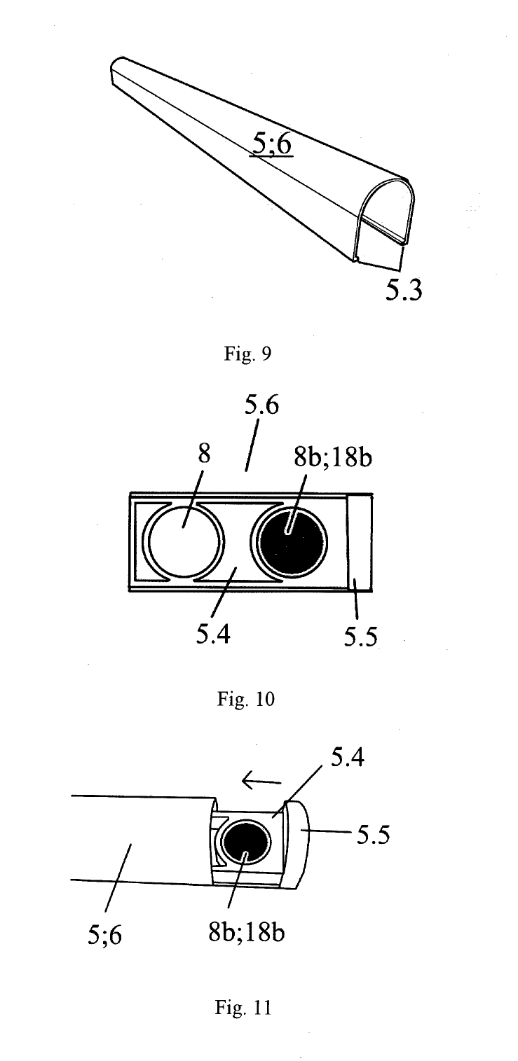

FIGS. 9 to 11 show external top and bottom regulating batten 5; 6 with magnets housed in the end parts 5.6 of the external battens 5; 6. Battens 5; 6 are formed as U shaped hollow tube that at its ends contains ribs 5.3 turned to the inner side of the U shaped tube. Ribs 5.3 serve for tightly fixing end parts 5.6 within battens 5; 6. End parts 5.6 are made in one piece that consists of a rectangular part 5.4 for housing at least one magnet and part 5.5 which closes open end of the battens 5; 6 when end parts 5.6 and battens 5; 6 are in assembled state (see FIG. 11).

According to one embodiment of the invention battens 5; 6 can be easily detached from the window pane 3 if force between inner and external magnets is overcome. In another embodiment end parts 5.6 are made in one piece that consists of a rectangular part 5.4 for housing at least one magnet, part 5.5 which closes open end of the battens 5; 6, which part 5.5 at its end contains projection in the form of an axle which at its end contains a detent wheel 5.7 (see FIG. 14). Detent wheel 5.7 is placed within a longitudinal guide 5.9. The longitudinal guide (5.9) has the cross section in the form of the hollow square tube enabling detent wheel (5.7) to glide along the longitudinal guide (5.9), where longitudinal guide (5.9) has one longitudinal opening for receiving said axle and enabling its movement along the said longitudinal opening, where along one longitudinal outer side of the guide (5.9) is firmly fixed longitudinal metal sheet which serves for fixing guide (5.9) to the window frame (5.8). By this technical solution it is achieved that battens 5; 6 can not be detached from the window pane 3.

Blinds system according to the present invention provides different implementation models. Model shown on FIGS. 4 and 5, exhibits example with the pleated blinds. In this implementation model with rails 1.2 are set vertically and blinds are set horizontally. In this mode of implementation blinds are lifted or lowered. However, rails 1.2 can be set horizontally and accordingly the blinds itself are installed to be in vertical position. In this mode of implementation regulation of blinds is horizontal.

According to another mode of implementation blinds are Venetian blinds with handle for regulation of slats. Handle is also operated by the magnets.

In one window it is possible to combine Venetian blinds and pleated blinds in which case blinds system contains separate blinds control system for Venetian blinds and for pleated blinds.

Blinds used in present blinds system can be Venetian blinds, pleated blinds, wooden blinds, plastic blinds, paper blinds or honey comb blinds.

Main object achieved by present solution is preventing damage caused by sliding, on the window panes of the external and internal batten assembly with magnets and of the blinds itself. By present technical solution, any contact of external/internal batten assembly and blinds with the window glass is prevented thus preserving in good condition of applied Low-E coating on the any side of the window pane.

1. Blinds system for installation between two insulated window panes (2; 3), the system comprising a window frame (5.8) bounding frame of the insulated window panes (2; 3) that consists of a pair mutually opposed profiles (1.1) and of a pair mutually opposed rails (1.2), blinds external (5; 6) and internal (4.1; 7) battens, where at the end of the battens (5, 6, 7, 4.1) are arranged end parts (4.2) containing at least one magnet (8a; 18a.) and end parts (5.6) containing at least one magnet (8b and 18b) where magnets (8a; 18a) are fitted to be in the opposite magnet pole in relation to the poles of the magnets (8b; 18b), where rails (1.2) are arranged to house opposite end parts (4.2) of the at least one batten (4.1; 7), wherein both rails (1.2) include a longitudinal flat tracks (1.3) and (1.4) arranged at a right angle for housing an end parts (4.2) of the at least one batten (4.1; 7), such the end parts (4.2) of the batten (4.1; 7) may slide along said rails (1.2) in said longitudinal flat tracks (1.3) and (1.4), characterized in that the longitudinal rails (1.2) include a longitudinal axle pins (4.4) positioned at a right angle on the longitudinal track (1.4), the pins (4.4) being arranged to get into keyways (4.5) of the end parts (4.2) in order to restrict the contact of internal (4.1; 7) batten assembly and blinds (12) with the window panes (2; 3) and to ensure only the longitudinal movement of the battens (4.1; 7) along the rails (1.2).

2. Blinds system according to claim 1, characterized by that the rails (1.2) are formed by bisected longitudinal hollow tube (1.6) sealed with the longitudinal flat track (1.3) and elongated part (1.5) extending from one end of the hollow tube (1.6) where on the end of elongated part (1.5) and perpendicular to the elongated part (1.5) an axle pin (4.4) is arranged in a manner that pin (4.4) is parallel with longitudinal track (1.3).

3. Blinds system according to claim 1, characterized by that the end part (4.2) is made in one piece that consists of a rectangular part (4.8) for housing at least one magnet and fitting inside battens (7; 4.1), where part (4.8) on the side that is facing window pane (2) when the blinds system is assembled has cavity (4.3) which contains at least one socket (8) for placing at least one magnet (8a, 18a), and of a part (4.9) that glides along the rail (1.2).

4. Blinds system according to claim 1, characterized by that the part (4.9) is formed by five mutually perpendicular flat surfaces where the surface oriented to the window pane (3) is provided with the longitudinal keyway (4.5) extending along the said surface, where keyway (4.5) has the shape and size that matches to the longitudinal axle pin (4.4) and its position is determined by the width of the longitudinal track (1.4) in a manner that the end parts (4.2) of the battens (4.1; 7) may slide along said rails (1.2).

5. Blinds system according to claim 3, characterized by that the part (4.8) on the edges, that are facing the window pane (2) when blinds system is assembled, contains two longitudinal slots that serve for fixing part (4.8) inside battens (7; 4.1).

6. Blinds system according to claim 1, characterized by that the battens (7, 4.1) are in the form of the hollow square tube with an extension (4.11) for fixation of the blinds, where at the inner part of the hollow square tube of the battens (7; 4.1) is provided with two oppositely placed projections (4.10) that serve for receiving two longitudinal slots and tightly securing parts (4.8) inside battens (7; 4.1), where the part (4.9) of the end part (4.2) has cross section and size that enables its adhering to the battens (7; 4.1).

7. Blinds system according to claim 1, characterized by that the battens (5; 6) are formed as U shaped hollow tube that at its ends contains ribs (5.3) turned to the inner side of the U shaped tube that serve for tightly fixing end parts (5.6) within battens (5; 6).

8. Blinds system according to claim 7, characterized by that end parts (5.6) are made in one piece that consists of a rectangular part (5.4) for housing at least one magnet (8b; 18b) and part (5.5) which closes open end of the battens (5; 6) when end parts (5.6) and battens (5; 6) are in assembled state.

9. Blinds system according to claim 7, characterized by that end parts (5.6) are made in one piece that consists of a rectangular part (5.4) for housing at least one magnet, part (5.5) which closes open end of the battens (5; 6), which part (5.5) at its end contains projection in the form of an axle on which end detent wheel (5.7), that glides along the longitudinal guide (5.9), is maintained.

10. Blinds system according to claim 9, characterized by that the longitudinal guide (5.9) has the cross section in the form of the hollow square tube enabling detent wheel (5.7) to glide along the longitudinal guide (5.9), where longitudinal guide (5.9) has one longitudinal opening for receiving said axle and enabling its movement along the said longitudinal opening, where along one longitudinal outer side of the guide (5.9) is firmly fixed longitudinal metal sheet which serves for fixing guide (5.9) to the window frame (5.8).

11. Blinds system according to claim 1, characterized by that the rails (1.2) and profiles (1.1) are formed of aluminum profiles.
